(19) United States
(12) Patent Application Publication
(10) Pub. No.: US 2023/0272179 A1
(43) Pub. Date: Aug. 31, 2023

(54) OPEN CELL POLYMER FOAM COMPOSITION WITH TUNABLE TORTUOSITY AND METHOD OF MAKING THE SAME

(71) Applicants: Braskem S.A., Camaçari (BR); CellMat Technologies S.L., Valladolid (ES)

(72) Inventors: Cristina Saiz-Arroyo, Valladolid (ES); Miguel Angel Rodriguez-Perez, Valladolid (ES); Patricia Torres-Regalado, Valladolid (ES); Javier García-Gonzalez, Valladolid (ES)

(73) Assignees: Braskem S.A., Camaçari (BR); CellMat Technologies S.L., Valladolid (ES)

(21) Appl. No.: 18/176,154

(22) Filed: Feb. 28, 2023

Related U.S. Application Data
(60) Provisional application No. 63/314,943, filed on Feb. 28, 2022.

(51) Int. Cl. C08J 9/10; C08L 23/08; C08L 23/06; C08J 9/00; C08K 3/26

(52) U.S. Cl. CPC C08J 9/103; C08L 23/0853; C08L 23/0869; C08L 23/06; C08J 9/0061; C08J 9/0066; C08K 3/26; C08L 2207/066; C08L 2203/14; C08L 2312/00; C08L 2310/00; C08J 2323/08; C08J 2323/06; C08J 2425/06; C08J 2203/04; C08J 2205/05; C08J 2205/044; C08K 2003/265

(57) ABSTRACT

A polymer composition including a crosslinkable thermoplastic matrix, a crosslinking agent, a blowing agent, and at least one cell opener is provided. A method of producing an open cell polymer foam from the polymer composition is also provided. The method includes heating a foamable precursor under positive pressure to a temperature greater than a decomposition temperature of the crosslinking agent and below a decomposition temperature of the chemical blowing agent to produce a primary foam. Then, the method includes heating the primary foam to a temperature greater than the decomposition temperature of the chemical blowing agent and then allowing the primary foam to cool to a temperature below a softening temperature of the crosslinkable thermoplastic polymer to form the open cell polymer foam. The produced open cell polymer foam has an open cell content of at least 80% immediately following the step of allowing the primary foam to cool.

### BACKGROUND

Polymer foams having an open cell structure, such as polyurethane foams, are useful for a wide range of applications including insulation, sound and shock absorption, cushioning, furniture and packaging. For open cell foams based on thermoplastics a high open cell content is typically achieved using mechanical deformation after a closed cell or partially closed cell foam is made. However, open cell foams that are made using mechanical deformation techniques typically have low tortuosity and suffer from poor thermal dimensional stability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer composition comprising a crosslinkable thermoplastic matrix, a crosslinking agent, a blowing agent, and at least one cell opener.

In another aspect, embodiments disclosed herein relate to an open cell polymer foam comprising a thermoplastic polymer foam. The foam has an open cell content of at least 80% and a density ranging from 13 to 60 kg/m³.

In yet another aspect, embodiments disclosed herein relate to a method of tuning the tortuosity of an open cell polymer foam. The method includes selecting a target tortuosity range, selecting a polymer composition based on the target tortuosity range, blending the polymer composition to form a foamable precursor, heating the foamable precursor under a positive pressure to a temperature greater than a decomposition temperature of the crosslinking agent and below a decomposition temperature of the chemical blowing agent to produce a primary foam, heating the primary foam to a temperature greater than the decomposition temperature of the chemical blowing agent, and allowing the primary foam to cool to a temperature of below a softening temperature of the crosslinkable thermoplastic polymer to form the open cell polymer foam having the target tortuosity range. The polymer composition includes a crosslinkable thermoplastic polymer, a crosslinking agent, a chemical blowing agent, and at least one cell opener.

In another aspect, embodiments disclosed herein relate to a method of producing an open cell polymer foam. The method includes heating a foamable precursor, where the foamable precursor includes a crosslinkable thermoplastic polymer, a crosslinking agent, a chemical blowing agent, and at least one cell opener. The heating the foamable precursor is conducted under positive pressure to a temperature greater than a decomposition temperature of the crosslinking agent and below a decomposition temperature of the chemical blowing agent to produce a primary foam. Then, the method includes heating the primary foam to a temperature greater than the decomposition temperature of the chemical blowing agent and then allowing the primary foam to cool to a temperature below a softening temperature of the crosslinkable thermoplastic polymer to form the open cell polymer foam. The produced open cell polymer foam has an open cell content of at least 80% immediately following the step of allowing the primary foam to cool.

In yet another aspect, embodiments disclosed herein relate to a cell opener masterbatch composition comprising a carrier polymer and 10 wt. % to about 75 wt. % of at least one cell opener.

Other aspects and advantages of the claimed subject matter will be apparent from the following description and the appended claims.

### BRIEF DESCRIPTION OF DRAWINGS

FIG. 1 is a schematic of a foaming step of a method in accordance with one or more embodiments.

FIG. 2 is a schematic of a foaming step of a method in accordance with one or more embodiments.

FIG. 3 is a schematic depiction illustrating tortuosity.

### DETAILED DESCRIPTION

In one aspect, embodiments disclosed herein relate to open cell polymer foams having tunable tortuosity and high open cell content. Open cell polymer foams are foams particularly useful due to the interconnectedness of the cells making up the foam. Foams in accordance with the present disclosure have uniquely tunable properties because the high open cell content may be achieved directly through the foam production process without mechanical deformation. The high open cell content is achieved through a combination of the base polymer composition and the method of making the foam. Moreover, embodiments are also directed to such polymer compositions as well as cell opener masterbatch compositions that may be combined with other components to arrive at the polymer compositions and presently described foams.

Polymer Composition

One or more embodiments of the present disclosure relate to a polymer composition including a crosslinkable thermoplastic matrix, a crosslinking agent, a blowing agent, and at least one cell opener.

Polymer compositions in accordance with the present disclosure include 100 parts by weight of a crosslinkable thermoplastic matrix suitable as a base material for the open cell polymer foam. The crosslinkable thermoplastic matrix may include different types of polyolefin polymers in particular embodiments. In one or more embodiments, the crosslinkable thermoplastic matrix may be selected from polyolefins, ethylene-based polymers, propylene-based polymers, and combinations thereof. In one or more embodiments, the crosslinkable thermoplastic matrix may be selected from the group consisting of low density polyethylene, high density polyethylene, linear low density polyethylene, copolymers of ethylene and one or more C3-C20 alpha olefins, polypropylene, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyether block amide copolymers, polyvinylidene fluoride, copolyesters, polyolefin elastomers, vulcanized thermoplastic elastomers or styrenic block copolymers, chlorinated derivatives thereof, and combinations thereof. In particular embodiments, the thermoplastic matrix is selected from ethylene vinyl acetate copolymer, low density polyethylene, and combinations thereof. In some embodiments, the thermoplastic matrix may include polymers generated from petroleum based monomers and/or biobased monomers (such as ethylene obtained from sugarcane derived ethanol). Commercial examples of biobased polymers include the “I'm Green”™ line of bio-polyethylenes and bio-ethylene vinyl acetate copolymers from Braskem S.A.

In one or more embodiments, the thermoplastic matrix in accordance with the present disclosure may include ethylene vinyl acetate copolymers (EVA polymer) that have various ratios of ethylene and vinyl acetate, in addition to including one or more optional additional comonomers. For example, the thermoplastic matrix in accordance with the present disclosure may include an ethylene vinyl acetate copolymer containing a percent by weight of vinyl acetate content, as determined by ASTM D5594, that ranges from a lower limit selected from one of 5 wt %, 8 wt %, 12 wt %, 15 wt %, 20 wt % to an upper limit selected from 25 wt %, 30 wt %, 35 wt %, 40 wt %, 60 wt %, 75 wt %, or 95 wt %, relative to the weight of the ethylene vinyl acetate copolymer, where any lower limit may be paired with any upper limit. Further, of this total amount of vinyl acetate, it is understood that at least a portion of that vinyl acetate may optionally be based on a renewable carbon source.

The thermoplastic matrix in accordance with the present disclosure may include an EVA polymer, where the EVA polymer exhibits a melt index as determined by ASTM D1238 that may range from a lower limit selected from one of 0.1, 1, 2, 5, 10, 20, of 50 to an upper limit selected from one of 50, 100, 200, 300, or 400 g/10 min measured with a load of 2.16 kg at 190° C., where any lower limit may be paired with any upper limit.

The thermoplastic matrix in accordance with the present disclosure may include an EVA polymer, where the density of the EVA polymer, as determined by ASTM D792, may range from a lower limit selected from one of 0.91, 0.95, 0.97, or 1.1 g/cm3 to an upper limit selected from one of 1.1, 1.5, 1.9, 1.21 or 1.25 g/cm³, where any lower limit may be paired with any upper limit.

Polymer compositions disclosed herein include a crosslinking agent suitable for crosslinking the crosslinkable thermoplastic matrix. The crosslinking agent may be chosen based upon the type of crosslinkable thermoplastic matrix being used. In one or more embodiments, crosslinking agent may be a peroxide. In other embodiments, the crosslinking agent may be a silane. In one or more embodiments, the crosslinking agent is selected from the group consisting of 1,1-bis(tert-butylperoxyl)-3,3,5 timethylcyclohexane, tert-butyl peroxybenzoate, 2,2-bis(tert-butylperoxyl) butane, dycumil peroxide, dieter amyl peroxide, dieter butyl peroxide, 1,2-bis(tert-butyl)-isopropyl bencene, 2,5-bis(tert-butyl peroxy)-2-5-dimethylhexane, 2,5-dimethyl-2,5di(tert-butylperoxyl)hexyne-3, 1,3-bis(tert-butylperoxyisopropyl)benzene, 1,1-bis(t-butylperoxy)-3,3,5-trimethylcyclohexane, n-butyl-4,4-bis(tert-tuylperoxy) valerate, benzoyl peroxide, p-chlorobenzoyl peroxide, 2,4-dichlorobenzoyl peroxide, tert-butyl perbenzoate, tert-butyl peroxyisopropyl carbonate, diacetyl peroxide, lauroyl peroxide, t-butyl cumyl peroxide and combinations thereof.

Crosslinking agents may also include peroxides such as benzoyl peroxide; dicumyl peroxide; di-tert-butyl peroxide; 00-Tert-amyl-0-2-ethylhexyl monoperoxycarbonate; tert-butyl cumyl peroxide; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di(tert-butylperoxide) valerate; di(2,4-dichlorobenzoyl) peroxide; di(4-methylbenzoyl) peroxide; peroxide di(tert-butylperoxyisopropyl)benzene; and the like.

Crosslinking agents may also include benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, butyl-peroxy-2-ethyl-hexanoate, tert-butyl peroxypivalate, tertiary butyl peroxyneodecanoate, t-butyl-peroxy-benzoate, t-butyl-peroxy-2-ethyl-hexanoate, 4-methyl-4-(t-amylperoxy)-2-pentanol, 4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3, 2,5-dimethyl-2,5-di(t-amylperoxy)hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobornyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-{3-(1-methylethenyl)-phenyl) 1-methylethyl]carbamate, 1,3-dimethyl-3-(t-amylperoxy)butyl N-[1-{3(1-methylethenyl)-phenyl}-1-methylethyl]carbamate, 1,3-dimethyl-3-(cumylperoxy))butyl N-[l-{3-(1-methylethenyl)-phenyl}-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-buty 1-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl)monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-cabonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

In one or more embodiments, the crosslinking agent may be included in the polymer composition in an amount ranging from 0.1 to 4.0 phr (parts by weight per hundred parts by weight of the crosslinkable thermoplastic matrix). For example, the crosslinking agent may be included in an amount having a lower limit of one of 0.1, 0.2, 0.3, 0.5, 0.7, 1.0, 1.2, 1.4, 1.5, 1.7 and 2.0 phr and an upper limit of one of 2.2, 2.4, 2.5, 2.7, 3.0, 3.2, 3.5, 3.7, and 4.0 where any lower limit may be paired with any mathematically compatible upper limit.

The polymer composition of one or more embodiments includes one or more blowing agents. Blowing agents may include solid, liquid, or gaseous blowing agents. Physical blowing agents may include volatile organic solvents such as hydrocarbons such as propane, n-butane, isobutane, n-pentane, isopentane, cyclopentane, n-hexane, isohexane, cyclohexane, alcohols such as ethanol and methanol, and gases such as nitrogen, carbon dioxide, carbon monoxide, hydrofluorolefins (HFOs), hydrofluocarbons (HFCs), and other physical blowing agents. The blowing agent may be a chemical blowing agent. In embodiments in which the blowing agent is a chemical blowing agent, the chemical blowing agent may be selected from the group consisting of azodicarbonamide, azobisisobutyronitrile, oxydibenzensulfonyl hydrazide, 5-phenyltetrazole, sodium bicarbonate, citric acid, citrates, urea, N,N′dinitrosopentamethylenetetramine, N,N′-dimethyl-N,N′-dinitrosoterephthalamide trinitrotimethyltriamine, 4,4′-oxybis(Benzenesulfonylhydrazide), paratoluenesulfonylhydrazide, diphenylsulfone-3,3′-disolfonylhydrazide, allylbis(sulfonylhydrazie), p-toluilenesulfonylsemicarbazide, 4,4′-oxybis(benzenesulfonylsemicarbazide), trichloromonofluoromethane, dichloromonofluoromethane, 5-morpholyl-1,2,3,4-thiatriazole, and combinations thereof. In one or more embodiments, the polymer composition may include a physical blowing agent and a chemical blowing agent.

In one or more embodiments, the blowing agent is included in the polymer composition in an amount ranging from 1 to 60 phr. For example, the blowing agent may be included in an amount having a lower limit of one of 1, 2.5, 5, 10, 15, 20, 25 and 30 phr and an upper limit of one of 35, 40, 45, 50, 55 and 60 phr, where any lower limit may be paired with any mathematically compatible upper limit.

Polymer compositions in accordance with the present disclosure also include at least one cell opener. Cell openers are useful for opening the cells during generation of the foam. Thus, the cell opener contributes to achieving a foam with a tunable tortuosity. Different types of cell openers may be selected based upon the desired properties of the foam made from the polymer composition. Types of cell openers include surface tension modifiers, rheology modifiers, and inorganic compounds. Cell openers may be used alone or in combination.

In one or more embodiments, the cell opener includes one or more surface tension modifiers. The surface tension modifier may be a polymeric matrix that can be blended with the previously described crosslinkable polymeric matrix. Examples of types of surface tension modifiers include styrenic-based materials, polyolefins, polyamides, acrylate-based polymers, polyesters, biodegradable products, rubbers and thermoplastic elastomers. In particular embodiments, the surface tension modifier may be selected from the group consisting of polystyrene, styrene acrylonitrile, polypropylene, polyolefins with a higher weight average molecular weight than the crosslinkable matrix, polymethylmethacrylate, polyethylene terephthalate, glycol modified polyethylene terephthalate, polyhydroxyalkanoates (PHAs), polylactic acid, starch, polyvinyl alcohol, natural rubber, ethylene-propylene-diene monomer (EPDM), polydimethyl siloxane (PDMS), acrylonitrile butadiene rubber (NBR), polyether block amide (PEBA), thermoplastic polyolefin elastomers (TPO), styrenic block copolymers (TPS), thermoplastic polyurethane elastomers (TPU), thermoplastic vulcanizates (also known as crosslinked thermoplastic elastomers), and thermoplastic copolyester elastomers.

In one or more embodiments, the surface tension modifier is present in an amount ranging from 1 to 50 phr. For example, the surface tension modifier may be included in an amount having a lower limit of one of 1, 5, 10, 15, 20 and 25 phr and an upper limit of one of 25, 30, 35, 40, 45 and 50 phr, where any lower limit may be paired with any mathematically compatible upper limit.

In one or more embodiments, the cell opener includes one or more rheology modifiers. The rheology modifier is a compound that interferes with the crosslinking process such that the rheology of the composition is changed. In one or more particular embodiments, the rheology modifier may be fatty acids of primary or secondary amides or bisamides, or amides or bisamides formed from primary or secondary fatty acids. For example, the rheology modifier may be erucamide, oleamide, docosanamide, stearamide, ethylene bis-oleamide, stearyl erucamide, or oleyl palmitamid. In one or more embodiments, the rheology modifier is present in an amount ranging from 0.05 to 7.0 phr. For example, the rheology modifier may be included in an amount having a lower limit of one of 0.05, 0.1, 0.2, 0.5, 1.0, 1.5, 2.0, 2.5, and 3.0 and an upper limit of one of 3.5, 4.0, 4.5, 5.0, 5.5, 6.0, 6.5 and 7.0, where any lower limit may be paired with any upper limit.

In one or more embodiments, the cell opener includes one or more inorganic compounds. The inorganic compounds promote the rupture of the cell walls during foaming. The inorganic compound may be any suitable inorganic compound in a granular or particulate form. Examples of types of inorganic compounds include but are not limited to talc, carbonates such as calcium carbonate and sodium carbonate, silicates, mica, silica, hydroxides such as metallic hydroxides (e.g., aluminum hydroxide and magnesium hydroxide), and clays such as montmorollonite and sepiolite. The inorganic material may have particles with a particle size ranging from nanometer-scale to micrometer-scale.

In one or more embodiments, the inorganic compound is present in an amount ranging from 1 to 50 phr. For example, the inorganic compound may be included in an amount having a lower limit of one of 1, 5, 10, 15, 20, and 25 phr and an upper limit of one of 30, 35, 40, 45 and 50 phr, where any lower limit may be paired with any upper limit.

Polymer compositions in accordance with the present disclosure may include one or more blowing agent accelerators (also known as kickers) that enhance or initiate the action of a blowing agent by lower the associated activation temperature. For example, blowing accelerators may be used if the selected blowing agent reacts or decomposes at temperatures higher than 140° C., such as 220° C. or more, where the surrounding polymer would be degraded if heated to the activation temperature. Blowing accelerators may include any suitable blowing accelerator capable of activating the selected blowing agent. In one or more embodiments, suitable blowing accelerators may include cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like.

In one or more embodiments, the blowing agent accelerator may be included in an amount ranging from 0.01 to 4.00 phr. For example, the blowing agent accelerator may be included in an amount having a lower limit of one of 0.01, 0.05, 0.10, 0.50, 1.00, 1.20, 1.50, 1.70, and 2.00 phr and an upper limit of one of 2.20, 2.40, 2.60, 2.80, 3.00, 3.20, 3.40, 3.60, 3.80 and 4.00 phr, where any lower limit may be paired with any mathematically compatible upper limit.

Polymer compositions disclosed herein may include a processing aid. In one or more particular embodiments, the processing aid may be stearic acid, glycerol monostearate (GMS), metallic stearates such as zinc stearate or magnesium stearate, waxes such paraffins, and polyolefin based waxes.

In one or more embodiments, the processing aid may be included in an amount ranging from 0.05 to 2.0 phr. For example, the processing aid may be included in an amount having a lower limit of one of 0.05, 0.1, 0.2, 0.5, 0.7 and 1.0 phr and an upper limit of one of 1.0, 1.2, 1.5, 1.7, and 2.0 phr, where any lower limit may be paired with any mathematically compatible upper limit.

Polymer compositions of the present disclosure may also include a cell enlarger. The cell enlarger may be a polymer having a linear-like chain architecture with the same nature as the crosslinkable thermoplastic matrix. Regardless, the molecular architecture of the crosslinkable thermoplastic matrix (branched or linear), the cell enlarger will be a polymer exhibiting a linear-like molecular chain. In one or more particular embodiments, the cell enlarger may be selected from the group consisting of linear low-density polyethylene, linear polypropylene, high density polyethylene and combination thereof.

In one or more embodiments, the cell enlarger may be included in an amount ranging from 1 to 30 phr. For example, the cell enlarger may be included in an amount having a lower limit of one of 1, 2, 5, 10, 12, and 15 phr and an upper limit of one of 15, 22, 25, 27 and 30 phr, where any lower limit may be paired with any mathematically compatible upper limit.

Polymer compositions in accordance with the present disclosure may include one or more property modifiers such as fillers and additives that modify various physical and chemical properties when added to the polymer composition during blending that include one or more polymer additives such as lubricants, antistatic agents, clarifying agents, nucleating agents, beta-nucleating agents, antioxidants, compatibilizers, antacids, light stabilizers such as HALS, IR absorbers, whitening agents, inorganic fillers, organic and/or inorganic dyes, anti-blocking agents, flame-retardants, plasticizers, biocides, adhesion-promoting agents, metal oxides, mineral fillers, glidants, oils, anti-oxidants, antiozonants, accelerators, pigments, colorants and vulcanizing agents.

Polymer compositions in accordance with the present disclosure may include one or more inorganic fillers as property modifiers such as talc, glass fibers, marble dust, cement dust, clay, carbon black, graphite, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium oxides, calcium carbonate, polyhedral oligomeric silsesquioxane (POSS), or recycled polymeric matrices, such as LDPE (low density polyethylene), EVA (ethylene vinyl acetate), HDPE (high density polyethylene), PP (polypropylene), among others. As defined herein, recycled polyolefins may be derived from regrind materials that have undergone at least one processing method such as molding or extrusion or foaming and the subsequent sprue, runners, flash, rejected parts, and the like, are ground or chopped.

In one or more embodiments, the property modifier may be included in an amount ranging from 0.01 to 50 phr. For example, the property modifier may be included in an amount having a lower limit of one of 0.01, 0.1, 1.0, 5.0, 10, 15, and 20 phr and an upper limit of one of 25, 30, 35, 40, 45 and 50 phr, where any lower limit may be paired with any mathematically compatible upper limit.

The polymer compositions described herein may be expanded and cured to generate polymer foams. The foams are generated in a process that, in combination with the aforementioned polymer composition, provides a high open cell content and a tunable tortuosity of the produced foam.

Cell Opener Masterbatch Composition

One or more embodiments of the present disclosure relate to a cell opener masterbatch composition. The cell opener masterbatch composition may include at least one cell opener and a carrier polymer. For example, a cell opener masterbatch stock may be formulated for storage or transport and, when desired, be combined with a thermoplastic matrix or other materials, such as the crosslinking agent and blowing agent, in order to produce a final polymer composition having concentration of constituent components described above that provides physical and chemical properties tailored to a selected end-used. Thus, a masterbatch composition may be formulated such that the concentration of the cell opener is greater than a desired final concentration of a cell opener in a polymer composition as previously described. While final polymer compositions of the present disclosure include a crosslinking agent and a blowing agent, such components may be omitted from a cell opener masterbatch in order to prevent premature crosslinking and foaming. The cell opener masterbatch generally includes at least one cell opener and a carrier polymer, which may be the same as or different from the thermoplastic matrix, and it may also include additional components such as cell enlargers, fillers, pigments and the like.

The carrier polymer included in the cell opener masterbatch composition may be the same as the thermoplastic matrix for the final polymer composition, however, other polymers may be used. In one or more embodiments, the carrier polymer may be selected from the group consisting of low density polyethylene, high density polyethylene, linear low density polyethylene, copolymers of ethylene and one or more C3-C20 alpha olefins, polypropylene, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyether block amide copolymers, polyvinylidene fluoride, chlorinated derivatives thereof, and combinations thereof. Thus, as noted above, the carrier polymer and the thermoplastic matrix may be selected to be the same or different, and even if selected to have the same polymer type, it is also understood that different grades of the same polymer type may be used.

As noted above, the concentration of the cell opener in the masterbatch may be greater than the concentration of the cell opener in the final polymer composition. In one or more embodiments, the masterbatch may include from about 10 wt. % to about 75 wt. % of the cell opener. The cell opener may be present in the masterbatch in an amount having a lower limit of one of 10 wt. %, 15 wt. %, 20 wt. %, 25 wt. %, 30 wt. %, 32 wt. %, 35 wt. %, 37 wt. %, 40 wt. %, 42 wt. %, 45 wt. %, 47 wt. %, and 50 wt. % and an upper limit of one of 25 wt. %, 30 wt. %, 32 wt. %, 35 wt. %, 37 wt. %, 40 wt. %, 42 wt. %, 45 wt. %, 47 wt. %, 50 wt. %, 52 wt. %, 55 wt. %, 57 wt. %, 60 wt. %, 62 wt. %, 65 wt. %, 67 wt. %, 70 wt. % and 75 wt. % where any lower limit may be paired with any mathematically compatible upper limit. The balance of the weight of the masterbatch composition may be the carrier polymer and additives as described above.

In one or more embodiments, a cell opener masterbatch composition may be blended with a crosslinking agent and a blowing agent (and other optional components described herein) to arrive at the polymer composition, or may be blended with a crosslinking agent, blowing agent, and crosslinkable thermoplastic matrix (and other optional components described herein) to arrive at the final polymer composition. It is envisioned that in this second scenario, where the cell opener masterbatch is blended with crosslinkable thermoplastic matrix, that such blend may include an amount of cell opener masterbatch sufficient to achieve the cell opener concentration as described above in the polymer composition. In one or more embodiments, the cell opener masterbatch may be included in the polymer composition in an amount having a lower limit of one of 0.1 wt. %, 0.5 wt. %, 1 wt. %, 2 wt. %, 3 wt. %, 4 wt. %, 5 wt. %, 10 wt. %, 15 wt. %, 20 wt. % and 25 wt. %, and an upper limit of one of 10 wt. %, 12 wt. %, 15 wt. %, 17 wt. %, 20 wt. %, 25 wt. %, 30 wt. %, 35 wt. %, 40 wt. %, 45 wt. % and 50 wt. % of the polymer composition, where any lower limit may be paired with any mathematically compatible upper limit.

Method of Making Open Cell Foam

In another aspect, one or more embodiments of the present disclosure relate to a method of making polymer foams from the previously described composition. Methods in accordance with one or more embodiments include blending a polymer composition to form a foamable precursor, and then expanding and curing the foamable precursor in a two-step process.

Polymer compositions in accordance with the present disclosure may be blended to form a foamable precursor in any conventional mixture device or means. In one or more embodiments, polymeric compositions may be blended by mixture in conventional kneaders, banbury mixers, mixing rollers, twin screw extruders, presses and the like. The blending is typically conducted at a temperature lower than the decomposition temperature of the crosslinking and blowing agent. For example, in one or more embodiments, the blending may be conducted at a temperature ranging from about 70° C. to 150° C. As is appreciated by those skilled in the art, the blending temperature will depend on the melting point or softening temperature of the crosslinkable thermoplastic matrix being used in the polymer composition and on the decomposition temperature of the crosslinking agents used.

In one or more particular embodiments, certain components of the polymer composition may be included in a cell opener masterbatch that is made separately and then blended with the additional components to form the foamable precursor. In such embodiments, the carrier polymer and the at least one cell opener are included in the cell opener masterbatch. The cell opener masterbatch may include other components as needed, and may be blended, with the components described above, to form the polymer composition and foamable precursor. A cell opener masterbatch may help improve dispersion of the cell opener(s) in the polymer composition and may be employed with any composition. However, a cell opener masterbatch may be particularly advantageous when using a surface tension modifier as a cell opener, particularly when the cell opener is a polymer with a higher softening temperature when compared to the crosslinkable thermoplastic matrix.

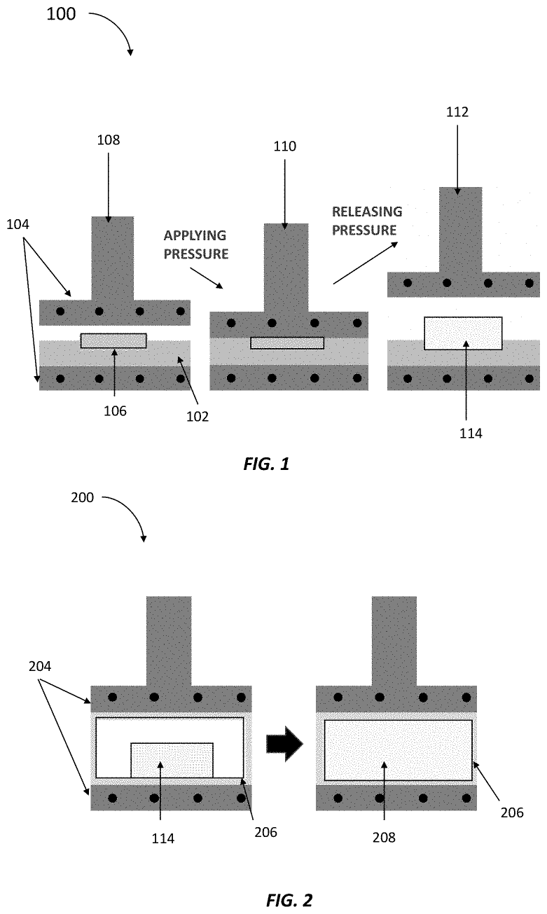

After the blending step to form a foamable precursor, the foamable precursor is heated in a first heating step. An exemplary embodiment of a first heating step 100 is shown in FIG. 1. FIG. 1 illustrates a mold 102 in between two hot plates 104 of a press. The foamable precursor 106 is placed in the mold 102 for the first heating step, as shown in the press labeled 108. This first heating step is conducted under a positive pressure. In one or more embodiments, and as shown in FIG. 1, pressure is applied by pressing the mold in a press 110. The pressure should be sufficient to maintain the volume of the foamable precursor 106 such that it does not expand more than 15% by volume, or not more than 10%, or not more than 5%, or not more than 3%, or not more than 2%, or not more than 1% in this step. As pressure is applied, the mold in which the foamable precursor is pressed is heated to a temperature greater than a decomposition temperature of the crosslinking agent and below a decomposition temperature of the chemical blowing agent. As is appreciated by those skilled in the art, this temperature will vary depending on the type of crosslinkable thermoplastic polymer, the crosslinking agent and the blowing agent being used. In an exemplary embodiment, the temperature of the first heating step may be in a range of from about 130° C. to 160° C. The foamable precursor is then held at the elevated temperature for a period of time long enough to ensure that the material reaches the desired crosslinking level. The time at elevated temperature will vary based on the composition and thickness of the foamable precursor. For example, the time at elevated temperature under pressure may be from about 40 to 60 minutes for a foamable precursor having a thickness of about 25 mm (millimeters). During this step, about 2% to 40% of the blowing agent may be decomposed. As would be appreciated by those skilled in the art, the amount of time at elevated temperature during this step depends on the thickness of the foamable precursor. A foamamble precursor having a thickness of about 25 mm should be heated for about 40 to 60 minutes. However, thicker specimens may require additional heating time and thinner specimens may require less heating time. Such adjustments may be made as needed as understood by a person of ordinary skill in the art.

After the first heating step, the pressure is released 112 and the foamable precursor expands to produce a primary foam 114. At this point, the foamable precursor expands into the primary foam by an expansion ratio of from about 1.1 to 10.0. For example, the expansion ratio from the foamable precursor to the primary foam may be about 1.1, 1.2, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0.

Then the primary foam is heated in a second heating step of the method as shown in FIG. 2. During this step 200, the primary foam 114 is heated using hot plates 204 similar to those used in the first step. The primary foam 114 is heated in a predetermined volume (such as a mold) to a temperature greater than the decomposition temperature of the chemical blowing agent. As is appreciated by those skilled in the art, this temperature will vary depending on the type of crosslinkable thermoplastic polymer and blowing agent being used. In an exemplary embodiment, the temperature of the second heating step may be in a range of from about 160° C. to 200° C. Additional external pressure may or may not be applied during this step, including expansion in a reduced pressure environment (i.e., vacuum), however, the volume in which the primary foam is heated is controlled in order to control the expansion ratio of the foam. In embodiments in which pressure is applied during this step, pressure may be applied using a moveable press with a piston, using a sealed mold and injecting a pressurized gas, or by performing this step in a pressure vessel, for example. During this step 200, the foam expands to fill the volume 206 and has an expansion ratio of from about 10 to 45 as compared to the initial volume of the foamable precursor. The expansion ratio during the second step may be about 10, 15, 20, 25, 30, 35, 40 or 45.

After the primary foam has expanded, it is allowed to cool to a temperature below the softening temperature of the polymer to form an open cell polymer foam 208 filling the predetermined volume. Cooling to a temperature below the softening temperature ensures that there is no additional unwanted expansion. After the foam has cooled, it may be removed from the volume in which it expanded. Immediately following the cooling step, the open cell foam may have an open cell content of at least 80%. The foam may also have a tortuosity within the selected tortuosity range.

Additional mechanical deformation steps may not be required to achieve the target tortuosity. However, in one or more embodiments, the open cell polymer foam may be mechanically deformed to change the tortuosity of the open cell polyolefin foam.

The previously described method of preparing an open cell polymer foam may be used to turn the tortuosity of the foam. In such instances, the method includes selecting a target tortuosity range, selecting a polymer composition based on the target tortuosity range, and then proceeding to make the polymer foam as previously described.

In contrast to conventional methods for preparing open cell polymer foams, an open cell content and a target tortuosity may be achieved directly from the foam synthesis process, meaning that mechanical deformation of the foam is not required to achieve the high open cell content and a certain tortuosity. That is to say the high open cell content and certain tortuosity may be achieved through a combination of the polymer composition and the synthesis method described herein. In contrast, conventional methods typically must use mechanical deformation to achieve a high open cell content. In accordance with the present methods, because the high open cell content is achieved directly from the composition and synthesis method, mechanical deformation, when used, may be to modify the tortuosity of the foam, rather than to increase the open cell content.

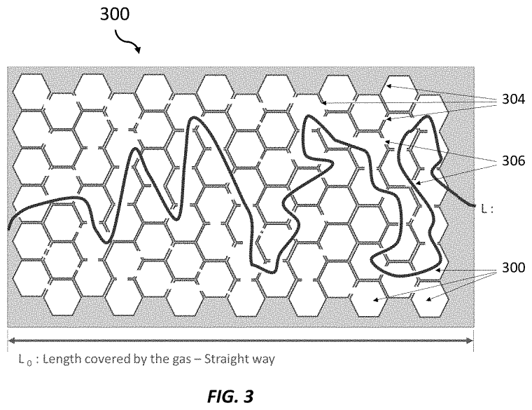

Tortuosity, as described herein, is a measure of how readily a fluid (i.e., gas or liquid) can be transported through the foam. Tortuosity is defined as the ratio between the real and apparent distances that fluid entrapped in the cellular structure has to cover to move from one side of the foam to the opposite side of the foam. FIG. 3 is a diagram used to exemplify how tortuosity is defined.

The equation used to describe tortuosity herein is shown in Formula (I):

$$T = \frac{L}{{L}_{0}} \qquad Formula ( I )$$

where T is tortuosity, L is the apparent length and L₀ is the real length. FIG. 3 shows an article 300 that has cells 302 and cell walls 304 defining the cells. Some cell walls 304 have holes 306 in them. In FIG. 3, the apparent length (L₀) is the length of the article 300 if a straight line is assumed. The real length (L) is the actual distance a fluid (such as a gas) travels in order to traverse the component, such as by passing through holes in cell walls. The tortuosity of the foam depends on the characteristics of the foam such as the open cell content, the number of holes present in the cell walls and the size of the holes.

As described herein, tortuosity is experimentally determined using an electrochemical measurement, as described below.

A solution of CuSO₄·5H₂O (0.4 M) may be used as auxiliary liquid. Two copper discs (15 mm in diameter) are employed as electrodes. The copper electrodes may be connected to an electrical source providing the alternating current (EA-3048B Elektro-Automatik GmbH, Germany).

First, the electrical conductivity of the solution without the foamed sample between the electrodes is measured in a fixed voltage range. The resistance of the solution without a sample between the electrodes (Rc) is determined applying Ohm's law. The measurements are performed in a range of voltages from 3 to 6 Volts in steps of 0.5 Volts. A gap of 2 minutes is established between each measurement. A conventional amperemeter and voltmeter are used to measure the voltage and intensity during the electrical experiments.

Once the resistance of the solution without the sample is measured, the electrical conductivity of the solution containing a foamed sample placed between the two copper electrodes is determined. For this purpose, cylindrical foam specimens with 25 mm in thickness and 30 mm in diameter are immersed for 14 hours in the solution before measuring to assess a proper and complete penetration of the auxiliary liquid inside the cellular structure. After this time, the samples are placed between the two copper electrodes and the electrical conductivity is measured in the same voltage range and with the same conditions and equipment as the ones used for the solution. The resistance of the solution with the sample between the electrodes (R_{f}) is then obtained using Ohm's law.

Tortuosity (T) is defined as the ratio between the resistance with the foamed sample between the cooper electrodes (R_{f}) and the resistance of the solution without foamed sample between the electrodes (R_{c}) using the equation shown in Formula (III):

$$T = \frac{{R}_{f}}{{R}_{c}} \qquad Formula ( III )$$

As noted above, methods in accordance with one or more embodiments include selecting a target tortuosity range of an open cell polymer foam. In one or more embodiments, a low target tortuosity range may be selected. In such embodiments, the target tortuosity is from 1.1 to 2.5. For example, the low target tortuosity may be 1.1, 1.2, 1.3, 1.4, 1.5, 1.6, 1.7, 1.8, 1.9, 2.0, 2.1, 2.2, 2.3, 2.4, or 2.5. In other embodiments, a high target tortuosity range may be selected. In such embodiments, the target tortuosity is from 2.5 to 6.0. For example, the high target tortuosity range may be 2.5, 2.7, 3.0, 3.2, 3.5, 3.7, 4.0, 4.2, 4.5, 4.7, 5.0, 5.2, 5.5, 5.7, or 6.0.

Once a target tortuosity has been selected, a polymer composition based on the target tortuosity range may be selected. In one or more embodiments, high tortuosity foams may be produced by using small amounts of the surface tension modifier. For example, an amount of 5 to 10 phr of a polystyrene polymer in an EVA matrix can result in foams having a high tortuosity in the range of 2.5 to 6. On the other hand, low tortuosity foams, with tortuosity in the range of 1.1 to 2.5, may be produced by including a surface tension modifier (for instance polystyrene) in an amount of 5 to 15 phr and a rheology modifier (for instance an amide of a fatty acid) in an amount of 1 to 3 phr. In addition, the combination of a surface tension modifier in a proportion of 5 to 15 phr with inorganic fillers in a proportion of 5 to 20 phr is a way to reduce the tortuosity of the foams. Once a polymer composition has been selected, open cell foam may be made as previously described from the polymer composition.

As noted above, in one or more embodiments, a target tortuosity may be achieved directly from the method of making the open cell foam. However, in one or more other embodiments, an optional mechanical deformation step may be used to change the tortuosity. For example, when an open cell foam having a higher tortuosity is made, the tortuosity may be decreased using mechanical deformation. The mechanical deformation typically includes compression and/or shear forces to break additional cell walls in the foam structure. In one or more particular embodiments, the foam may be mechanically deformed using rolls, for example a set of two rolls that may be set to different rotation speeds and deformation ratios.

Open Cell Polymer Foam

Open cell polymer foams made from the previously described compositions using the previously described methods may provide a unique combination of properties useful for a wide range of applications. Open cell content is a measure of the degree of interconnectedness of the cells in a polymer foam. For example, a high open cell content indicates a high level of interconnectedness of the cells in the polymer foam. As defined herein, an open cell polymer foam is a foam having an open cell content of at least 80%.

The open cell content of a polymer foam described herein may be determined using a gas pycnometry. A gas pycnometer operated under nitrogen or argon gas may be used and the open cell content may be determined using the equation shown in Formula (II):

$$C ( \% ) = \frac{{V}_{Sample} - {V}_{Pycnometer}}{{V}_{Sample} \cdot ( 1 - \frac{{ρ}_{Foam}}{{ρ}_{Solid}} )} \cdot 100 \qquad Formula ( II )$$

where Vₛₐₘₚₗₑ is the geometric volume of the foam, measured using conventional methods to measure the dimensions of materials (for example, by using a caliper), V_{pycnometer} is the volume of the foam measured using the gas pycnometer, ρ_{foam} is the density of the foamed material, and ρ_{solid} is the density of the corresponding solid counterpart. To eliminate the potential effect of an undesirable deformation of the material during the measurement due to the effect of the pressure exerted by the gas introduced in the pycnometer, the volume given by the pycnometer V_{Pycnometer} is measured at different pressures. The volume of the sample measured with the pycnometer, V_{Pycnometer}, as a function of pressure is used to represent the

$$\frac{{V}_{Sample} - {V}_{Pycnometer}}{{V}_{Sample}}$$

as a function of pressure. The obtained curve is fitted to a linear trend to calculate the volume measured by the pycnometer at zero pressure. The obtained value of this volume at zero pressure is used to calculate the open cell content using Formula (II). In one or more embodiments, the polymer foam may have an open cell content of at least 80%, at least 82%, at least 85%, at least 87%, at least 90%, at least 92%, at least 95%, at least 98% or at least 99%.

Open cell polymer foams disclosed herein may have a suitable density, and in some instances, may have an ultra-low density. In one or more embodiments, the polymer foam may have a density ranging from 13 kg/m³ to 60 kg/m³ as determined according to ASTM D3575-00, Suffix W-Density. In embodiments in which the open cell polymer foams have an ultra-low density, they may have a density of less than 20 kg/m³, less than 18 kg/m³, or less than 15 kg/m³ as determined according to ASTM D3575-00, Suffix W-Density.

Open cell polymer foams disclosed herein may have particularly small cell sizes as compared to conventional open cell foams. In one or more embodiments, the polymer foams may have average cell sizes ranging from 50 to 700 microns when measured using scanning electron microscopy according to ASTM D3576-98. In particular embodiments in which a smaller cell size is desired, the polymer foams may have average cell sizes ranging from 50 to 250 microns when measured using scanning electron microscopy according to ASTM D3576-98. The average cell size may have a lower limit of one of 50, 75, 100, 125, 150, 175, and 200 microns and an upper limit of one of 175, 200, 225, 250, 375, 300, 350, 400, 500, 600 and 700 microns, where any lower limit may be paired with any mathematically compatible upper limit.

Open cell polymer foams disclosed herein display unique mechanical properties. For example, when subjected to compressive strain, the response is strain-rate dependent. When a polymer foam having high tortuosity is subjected to a compressive strain performed at a low strain rate, it behaves as a typical flexible open cell product such as a flexible polyurethane foam. However, when this same foam product is subjected to a compressive test performed a high strain rate (e.g., an impact test), it behaves very similarly to a closed cell foam and consequently, is not at all similar to a flexible polyurethane foam. Without wishing to be bound by any particular mechanism of theory, it is believed that the reason for this strain-rate dependent behavior is due to having a high tortuosity in the cellular structure. When the strain rate is low, the gas enclosed in the cellular structure has enough time to leave the material when it is deformed (i.e., the time needed for gas escape is less than the time scale of the experiment) and consequently (and unlike in closed cell foams), the gas phase does not contribute to the achieved stress values. However, when the strain rate is high, the gas enclosed in the cells comprising the cellular structure does not have time to escape from the structure since the time it requires to leave the structure is higher than the time scale of the experiment. Consequently, as a result, when the product is subjected to an impact test there is a positive contribution of the gas phase to the material stress. This dual nature of the foams when it comes to the response to a compressive strain makes them ideal candidates for applications requiring both impact protection and comfort.

Open cell foams produced using conventional methods that require mechanical deformation for cell opening suffer from reduced thermal stability due to the mechanical opening of the cells. Thus, polymer foams disclosed herein provide improved thermal stability as compared to conventional open cell foams. In one or more embodiments, the polymer foam may have a thermal dimensional stability on average of +1% in each direction (length, width, and thickness) when measured at 70° C. according to ASTM D3575, Suffix S Thermal Stability. In one or more embodiments, the polymer foam may have a thermal dimensional stability on average of ±5% in each direction (length, width, and thickness) when measured at 85° C., 90° C., or 100° C. according to ASTM D3575, Suffix S Thermal Stability. In one or more exemplary embodiments, the polymer foam may have a thermal stability of ±5% when measured at 85° C. for a foam based on EVA with a vinyl acetate content of 19%, or measured at 100° C. for a foam based on LDPE, or when measured at 90° C. for a foam based on EBA with a butyl acrylate content of 17%.

Sound absorption is an important application of flexible polyurethane foams. These materials typically display its maximum ratio of absorption at frequencies higher than 2000-2500 Hz. However, for some particular applications, materials having good absorption capacity below 2000 Hz are required. The polymer foams disclosed herein provide higher sound absorption capacity below 2000 Hz as compared to conventional foams, such as flexible polyurethane foams. The polymer foam may have an average sound absorption capacity (\tilde{α}) between f₁=500 Hz and f₂=2000 Hz of at least 0.50 when measured according ASTM 1050-98 and calculated using the equation shown in Formula (IV):

$$\tilde{α} = \frac{{\int }_{f 1}^{f 2} α ( f )}{{f}_{2} - {f}_{1}} . \qquad Formula ( IV )$$

The polymer foams disclosed herein display a high oil absorption capacity. Foams having low tortuosity have many characteristics useful for oil spill remediation. The extremely low density allows the foams to absorb a high volume of oil per volume of foam. Additionally, flexible polyolefins like LDPE or EVA can be used as the crosslinkable thermoplastic in one or more embodiments, providing a flexible foam for oil absorption which allows the foam to be reusable. Once they absorb the oil, flexible foams can be squeezed and be re-used for a high number of cycles. The open cell content and low density of the foams disclosed herein also contributes to high and efficient oil absorption. Polyolefin-based materials, such as many of the crosslinkable thermoplastic matrix materials disclosed herein are hydrophobic and oleophilic, which provides oil-water selectivity.

Oil absorption capacity described herein may be determined by placing a foam sample on the oil surface. The foam is not immersed or squeezed, but rather placed on top of the oil sample and left for a period of ten minutes. The oil absorption is calculated using the equation shown in Formula (IV):

$$\frac{{W}_{Oil}}{{W}_{Foam}} = \frac{{W}_{1 {0}^{′} - Oil} - {W}_{Initial}}{{W}_{Initial}} \qquad Formula ( IV )$$

where Wₒᵢₗ/W_{foam} is the oil absorption capacity, W_{10′-Oil} is the weight of the foam after having been placed on the oil for 10 minutes, Wᵢₙᵢₜᵢₐₗ is the initial weight of the foam prior to being placed on the oil. This test may be repeated any number of times by squeezing the oil out of the foam and performing the test again. A similar test may also be performed for water absorption using the same equation (with all oil values being replaced with water). In one or more embodiments, the oil absorption capacity of the open cell foams of the present disclosure may be at least 25 grams of oil, W_{Oil}, per gram of foam, W_{Foam}, or at least 30 grams of oil, W_{Oil}, per gram of foam, W_{Foam}, or at least 35 grams of oil, W_{Oil}, per gram of foam, W_{Foam}, or at least 40 grams of oil, W_{Oil}, per gram of foam, W_{Foam}, or at least 45 grams of oil, W_{Oil}, per gram of foam, W_{Foam}.

In an exemplary embodiment, the oil absorption capacity may be up to 25 grams of oil, W_{Oil}, per gram of foam, W_{Foam}, for an open cell EVA foam (vinyl acetate content 12%) with a density of 22 kg/m³ and a tortuosity of 2.6. In another exemplary embodiment, the oil absorption capacity can be as high as 43 grams of oil, W_{Oil}, per gram of foam, W_{Foam}, for an open cell EVA foam (vinyl acetate content 18%) with a density of 17 kg/m³ and a tortuosity 1.9.

Open cell foams in accordance with one or more embodiments may have a high capability to dampen vibrations. This property can be measured by the tan δ, i.e the ratio between the storage modulus (E′) and the loss modulus (E″) in an experiment of dynamic mechanical analysis (DMA) performed in compression mode according to ASTM D5024-01. The open cell foams may have tan S values at 23° C. and 1 Hz of frequency greater than 0.5, or greater than 0.7, or greater than 0.9. In one or more particular embodiments, the open cell foams may have tan S values at 23° C. and 1 Hz of frequency greater than 0.5 for an open cell EVA foam (vinyl acetate content 18%) with a density of 17 kg/m³ and a tortuosity of 1.9. The tan S at 23° C. and 1 Hz of frequency may be as high as 0.9 for an open cell EBA foam (butyl acrylate content 17%) with a density of 20 kg/m³ and a tortuosity of 1.9.

The open cell foams described herein can be readily thermoformed into complex shapes using conventional methods involving pressure (or vacuum) and temperature. In addition, the foams can be laminated to other materials (textiles, foams, solid polymers, etc.) using traditional approaches, such as adhesive bonding or thermal bonding among others. Moreover, the materials can be washed using conventional washing machines involving standard temperature programs and laundry detergents. Such properties make the foams useful for applications in the clothing industry to manufacture elements such as brassieres, body protection elements for sports, thermal insulation clothes, cups, etc.

Articles

Open cell polymer foams in accordance with one or more embodiments of the present disclosure may be used for the production of a number of polymer articles used for a diverse array of end-uses. Such applications include cushioning (such as seats, mattresses, cushions, mats), protection elements for the sports sector, packaging for different types of goods, sealing applications and gaskets, liquid absorption (water or oil-based), filtering, acoustic absorbers, clothing, bras, carpet underlay, furniture, vibration dampening elements, automotive related elements (such as crash pads, carpet backing, energy management, filters, headliners, headrests, armrests, seating, sound insulation (roofs), steering wheels, sun visors, trim, vibration dampening), seats for bicycles and motorcycles, helmets, crafts, diapers, ear plugs, electronics, toys, sanitary napkins, sealers for the construction sector, thermal insulation, cushioning for precise apparatuses or transport or glass, carriers for septic tanks, sealing and/or sound absorption elements for systems including air conditioning systems, refrigerating systems, speakers, and personal computers, and sealers for LCD televisions.

### Examples

Samples Formulation

Examples I-VI are open cell foams prepared from different formulations according to the teachings of the present disclosure. Sample formulations for Examples I-VI are presented in Table 1. Examples I-III are open cell foams based on formulations comprising EVA (ethylene-vinyl acetate copolymer) with 18 wt % of vinyl acetate as the crosslinkable thermoplastic matrix; Example IV is an ultra low-density open cell foam based on an EBA (ethylene butyl acrylate copolymer) with 17% of butyl acrylate as the crosslinkable thermoplastic matrix; Example V is a high tortuosity open cell foam based on LDPE (low density polyethylene) as the crosslinkable thermoplastic matrix; and Example VI is an ultra-low density foam based on an EVA with 18% of vinyl acetate as the crosslinkable thermoplastic matrix.

TABLE 1
Sample formulations

| | | Example | Example | Example | Example | Example | Example |
|---|---|---|---|---|---|---|---|
| | | I | II | III | IV | V | VI |
| Component | Commercial | Phr | Phr | Phr | Phr | Phr | Phr |
| | Name/Grade | | | | | | |
| Thermoplastic | EVA-3019 PE | 100 | 100 | 100 | 0 | 0 | 100 |
| Matrix | from Braskem | | | | | | |
| EVA-18 | | | | | | | |
| EBA-17 | Ebantix 1715 | 0 | 0 | 0 | 100 | 0 | 0 |
| | from Repsol | | | | | | |
| LDPE | LDPE PB 681 | 0 | 0 | 0 | 0 | 100 | 0 |
| | from Braskem | | | | | | |
| Azodi- | Unicell D800 | 20 | 22 | 20 | 25 | 18 | 25 |
| carbonamide | from Dongjin | | | | | | |
| Dicumyl | Luperox DCP | 0.47 | 0.45 | 0.3 | 0.35 | 0.45 | 0.55 |
| Peroxide | from Arkema | | | | | | |
| Calcium | Omyacarb 10 | 12 | 0 | 0 | 0 | 0 | 8 |
| Carbonate | from Omya | | | | | | |
| Polystyrene | Polystyrene | 0 | 7 | 0 | 7 | 10 | 15 |
| | Crystal 1160 | | | | | | |
| | from Total | | | | | | |
| Z-docos-13- | Crodamide ER- | 0 | 0 | 2.5 | 0 | 0 | 0 |
| enamide | BE from Croda | | | | | | |
| Zinc Stearate | ZnSt ™ from | 0.5 | 0.1 | 0.1 | 0.2 | 0.15 | 0.2 |
| | Faci | | | | | | |
| Stearic Acid | Stearic Acid 301 | 0.5 | 0.5 | 0.5 | 0.5 | 0.5 | 0.5 |
| | from Renichem | | | | | | |

Open Cell Foams Preparation Method

Open cell foam examples presented herein were prepared using the following process steps.

1. Mixing of the Components

1.a. In the case of Example I and III, the foamable precursors were produced using a conventional two-roll mill, with the two rolls heated at 118° C. with a mixing time of 15 minutes. The equipment used was a DW5110 from Hefei Fanyuan Instrument Co., ltd.

1.b. For those formulations containing polystyrene (PS) (Examples II, IV, V and VI) a cell opener masterbatch containing the base polymer of each formulation as the carrier polymer and PS as cell opener in a weight proportion of 70:30 (carrier:cell opener) was prepared. This masterbatch was produced in a twin screw extruder ZK 25 T Teachline from Dr. Collin using temperatures in the range of 100° C. (in the hopper) to 180° C. (in the die).

Then, this masterbatch was incorporated in the formulation by using a conventional two-roll mill, with the two rolls heated at 118° C. with a mixing time of 15 minutes to have the proportion of materials in the foamable precursor indicated in Table 1. The equipment used was a DW5110 from Hefei Fanyuan Instrument Co., ltd.

2. First Heating Step to Produce the Primary Foam

This step was performed in a conventional two hot plate press fabricated by Talleres Remtex (Barcelona, Spain). The mold was made of aluminum. The internal dimensions of this mold were 79×79×25 mm³. The conditions used in each experiment are detailed in Table 2. The mold was completely filled with the foamable precursor produced during the mixing step.

3. Second Heating Step to Produce the Open Cell Foam

This step was performed in a conventional two hot plate press fabricated by Talleres Remtex (Barcelona, Spain). The mold to introduce the primary foam was made of aluminum. The internal dimensions of this mold were 200×200×100 mm³. The conditions used in each experiment are detailed in Table 2.

4. Cooling Step to a Temperature Below the Softening Temperature

This cooling step was performed by introducing the mold used in the second heating step in water for 40 minutes.

The processing conditions used to produce foams from Examples I-VI are summarized in Table 2.

TABLE 2
Process conditions for preparation of open cell foams for Examples I-VI

| | Conditions | Example I | Example II | Example III | Example IV | Example V | Example VI |
|---|---|---|---|---|---|---|---|
| First | Temperature | 150 | 150 | 150 | 148 | 154 | 148 |
| foaming | (° C.) | | | | | | |
| step | Time (min) | 45 | 42 | 45 | 45 | 45 | 55 |
| | Pressure | 110 | 110 | 110 | 110 | 110 | 110 |
| | (bar) | | | | | | |
| Second | Temperature | 178 | 176 | 178 | 175 | 180 | 175 |
| foaming | (° C.) | | | | | | |
| step | Time (min) | 50 | 50 | 50 | 55 | 50 | 55 |
| | Pressure | Atmospheric | Atmospheric | Atmospheric | Atmospheric | Atmospheric | Atmospheric |
| | | pressure | pressure | pressure | pressure | pressure | pressure |
| Cooling | Time (min) | 20 | 20 | 20 | 20 | 20 | 20 |
| Step | | | | | | | |

Open Cell Foam Properties

Open cell foams prepared according to the formulation and preparation methods as disclosed above were assessed for density, open cell content and tortuosity. Properties of the foams of Examples I-VI are shown in Table 3.

TABLE 3
Properties of the foams

| Property | Example I | Example II | Example III | Example IV | Example V | Example VI |
|---|---|---|---|---|---|---|
| Density (kg/m³) | 22.3 | 21.4 | 23.7 | 15.2 | 26.7 | 14.9 |
| Open Cell Content (%) | 95.6 | 96.8 | 95.2 | 98.9 | 95.5 | 98.4 |
| Tortuosity | 2.7 | 3.1 | 2.0 | 1.8 | 2.7 | 2.9 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymer composition comprising:
a crosslinkable thermoplastic matrix;
a crosslinking agent;
a blowing agent; and
at least one cell opener.

2. The polymer composition of claim 1, wherein the crosslinkable thermoplastic matrix is selected from the group consisting of low density polyethylene, high density polyethylene, linear low density polyethylene, copolymers of ethylene and one or more C3-C20 alpha olefins, polypropylene, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyether block amide copolymers, polyvinylidene fluoride, copolyesters, polyolefin elastomers, vulcanized thermoplastic elastomers or styrenic block copolymers, chlorinated derivatives thereof, and combinations thereof.

3. The polymer composition of claim 1, wherein the at least one cell opener is selected from the group consisting of a surface tension modifier, a rheology modifier, an inorganic compound, and combinations thereof.

4. The polymer composition of claim 3, wherein when the at least one cell opener includes the surface tension modifier, the surface tension modifier is present in an amount ranging from 1 to 50 phr, and wherein the surface tension modifier is selected from the group consisting of polyamide, polystyrene, styrene acrylonitrile, polypropylene, polyolefins with a higher weight average molecular weight than the crosslinkable thermoplastic matrix, polymethylmethacrylate, polyethylene terephthalate, glycol modified polyethylene terephthalate, polyhydroxyalkanoates, polylactic acid, starch, polyvinyl alcohol, natural rubber, ethylene-propylene-diene monomer, polydimethyl siloxane, acrylonitrile butadiene rubber, polyether block amide, thermoplastic polyolefin elastomers, styrenic block copolymers, thermoplastic polyurethane elastomers, thermoplastic vulcanizates, thermoplastic copolyester elastomers, and combinations thereof.

5. The polymer composition of claim 3, wherein when the at least one cell opener includes the rheology modifier, the rheology modifier is present in an amount ranging from 0.05 to 7.0 phr, and wherein the rheology modifier is a fatty acid of primary or secondary amides or bisamides and combinations thereof.

6. The polymer composition of claim 3, wherein when the at least one cell opener includes the inorganic compound, the inorganic compound is present in an amount ranging from 1 to 50 phr, and wherein the inorganic compound is selected from the group consisting of talc, calcium carbonate, sodium carbonate, silicates, mica, silica, aluminum hydroxide, magnesium hydroxide, montmorollonite, sepiolite and combinations thereof.

7. An open cell polymer foam prepared from the composition of claim 1.

8. An open cell polymer foam comprising:
a thermoplastic polymer foam, the foam comprising:
an open cell content of at least 80%; and
a density ranging from 13 to 60 kg/m³.

9. The open cell polymer foam of claim 8 comprising a tortuosity of 1.1 to 2.5.

10. The open cell polymer foam of claim 8 comprising a tortuosity of 2.5 to 6.0.

11. The open cell polymer foam of claim 8 comprising an average cell size ranging from 50 to 700 microns.

12. An article comprising the open cell polymer foam of claim 8.

13. A method of tuning a tortuosity of an open cell polymer foam, the method comprising:
selecting a target tortuosity range;
selecting a polymer composition based on the target tortuosity range;
blending the polymer composition to form a foamable precursor, the polymer composition comprising:
a crosslinkable thermoplastic polymer;
a crosslinking agent;
a chemical blowing agent; and
at least one cell opener;
heating the foamable precursor under a positive pressure to a temperature greater than a decomposition temperature of the crosslinking agent and below a decomposition temperature of the chemical blowing agent to produce a primary foam;
heating the primary foam to a temperature greater than the decomposition temperature of the chemical blowing agent; and
allowing the primary foam to cool to a temperature of below a softening temperature of the crosslinkable thermoplastic polymer to form the open cell polymer foam having the target tortuosity range.

14. A method of producing an open cell polymer foam, the method comprising:
heating a foamable precursor, wherein the foamable precursor comprises:
a crosslinkable thermoplastic polymer;
a crosslinking agent;
a chemical blowing agent; and
at least one cell opener;
wherein the heating the foamable precursor comprises heating under positive pressure to a temperature greater than a decomposition temperature of the crosslinking agent and below a decomposition temperature of the chemical blowing agent to produce a primary foam;
heating the primary foam to a temperature greater than the decomposition temperature of the chemical blowing agent, and
allowing the primary foam to cool to a temperature below a softening temperature of the crosslinkable thermoplastic polymer to form the open cell polymer foam;
wherein the open cell polymer foam has an open cell content of at least 80% immediately following the step of allowing the primary foam to cool.

15. The method of claim 14 further comprising, prior to the heating step, blending the crosslinkable thermoplastic polymer, the crosslinking agent, the chemical blowing agent, and the at least one cell opener to form the foamable precursor.

16. The method of claim 14, further comprising, prior to the blending step, creating a cell opener masterbatch comprising a carrier polymer and the at least one cell opener, wherein the blending step comprises blending the masterbatch with the crosslinking agent and the chemical blowing agent and optionally with the crosslinkable thermoplastic.

17. The method of claim 14, wherein during the heating the foamable precursor under a positive pressure, the foamable precursor expands to an expansion ratio of from 1.5 to 10.0.

18. The method of claim 14, wherein during the heating the primary foam, the primary foam expands to an expansion ratio of from 15 to 45 with respect to the initial volume of the foamable precursor.

19. An open cell polymer foam made from the method of claim 14.

20. A cell opener masterbatch composition comprising:
a carrier polymer; and
10 wt. % to about 75 wt. % of at least one cell opener.
